(19) United States
(12) Patent Application Publication
(10) Pub. No.: US 2014/0205754 A1
(43) Pub. Date: Jul. 24, 2014

(54) METHOD FOR PARTIALLY DYEING FILMS

(71) Applicants: Alexander Wieser, Wien (AT); Martin Wieser, Wien (AT)

(72) Inventors: Alexander Wieser, Wien (AT); Martin Wieser, Wien (AT)

(21) Appl. No.: 14/130,002

(22) PCT Filed: Jun. 11, 2012
(86) PCT No.: PCT/EP2012/061000

§ 371 Date: Feb. 18, 2014

(30) Foreign Application Priority Data
Jun. 30, 2011 (AT) A 961/2011

(51) Int. Cl. G03C 11/18

(52) U.S. Cl. CPC G03C 11/18
USPC 427/282

(57) ABSTRACT

A method for partially dyeing films in which a black-and-white film is guided through a dye bath.

### CROSS-REFERENCE TO RELATED APPLICATIONS

The present application is a National Stage Application of PCT International Application No. PCT/EP2012/061000 (filed on Jun. 11, 2012), under 35 U.S.C. §371, which claims priority to Austrian Patent Application No. A 961/2011 (filed on Jun. 30, 2011), which are each hereby incorporated by reference in their respective entireties.

### TECHNICAL FIELD

Embodiments relate to a method for partially dyeing films in which a black-and-white film is guided through a dye bath.

### BACKGROUND

In the first decades of the twentieth century, it was usual to dye black-and-white films in sections to achieve colour effects. Within the framework of this invention there is in this context talk of a complete dyeing, i.e. that the film section concerned is completely dyed and it is not attempted to selectively dye individual objects presented in a specific manner. Even with this complete dyeing, however, it is usual to dye different film sections, for example, scenes, in different colours in order to make the film more realistic.

When restoring such films it is therefore necessary to develop corresponding technologies in order to give the observer of a cine film largely the same impression as was the case with the original film. Typically, a black-and-white version of the film is available to the restorer as a negative or positive as well as more or less well preserved copies of the dyed film.

It is now the object to provide the highest possible quality version of the dyed film. To this end various methods have been developed. In the so-called inter-negative process, a dyed positive copy of the film which has been preserved as well as possible is used to produce a colour negative, and colour-positive copies are produced from this colour negative. A disadvantage with this method is that the usually bleached-out original colours are reproduced so that it is not possible to reproduce the original colour impression. In addition, this method produces a colour negative which is also not desirable in the sense of a museum preservation.

In the so-called Desmet process, initially a black-and-white negative is produced from an available positive and from this, a colour positive is produced by mixing coloured light during the development. A disadvantage with this process is that the contrast deteriorates since both the white and also the black image components are dyes.

In order to avoid these disadvantages it would theoretically be possible to cut the black-and-white film copy to be dyed into individual film strips and dye these separately from one another in different colours. During the restoration of films, cutting and gluing together again is however undesirable since the adhesive points could become loose during projection and the film thereby becomes damaged.

U.S. Pat. No. 1,787,824 A relates to a method for dyeing sound films in which the additional problem is that the sound track should not be dyed in order not to disturb the sound transmission. Here the dye is applied by means of inking rollers and the application of dye to the sound track is prevented by a covering tongue. The disadvantages of the application by means of inking rollers are the adhesive points required due to the process and the merely externally applied dye layer which is not incorporated in the gelatine layer. Various adhesive tapes are known from European Patent Publication No. EP 1 719 808 A and U.S. Patent Publication No. 2003/0198785 A.

### SUMMARY

It is the object of embodiments to provide a solution which avoids these disadvantages and which allows a technically correct 1:1 reproduction, consistent with archiving, of originally dyed positive films so that the original impression is largely achieved.

In accordance with embodiments, this is provided by covering the coating side of the film before treatment in the dye bath by an adhesive tape which completely covers the image sections not to be dyed. The covering of the image sections not to be dyed is the minimum condition, other sections such as the perforation can additionally also be dyed.

It is essential to the embodiments that the film can be dyed in one piece, i.e., need not be cut in order to achieve dyed and non-dyed or differently dyed sections.

Another important aspect of embodiments is that there are large degrees of freedom on the choice of dyes and dye shades. This means that even if only bleached-out or poorly preserved colour copies of a film are available, a colour version can be produced which comes close to the original state. At the same time, it is also possible to take account of variations of the projection technique such as, for example, the different colour temperature of the light sources of projection apparatus in order to achieve an image which is as true as possible to the original in the end effect on the linen, which corresponds as far as possible to the original in historical play-back conditions.

It is furthermore essential that only a black-and-white negative is required in this process so that the process is completely consistent with a conservational aspect.

It is further of particular advantage that after treatment in the dye bath the adhesive tape is removed. The removal should be accomplished free from residue. Damage to the film is avoided in this way.

A further particularly favourable embodiment provides that a cohesive film strip in one piece is partially covered several times in succession with an adhesive tape and then guided through a dye bath. In this way, as provided in the original, successive scenes of a film can be dyed differently without needing to cut the film.

A preservation of the negative in the original form is in particular achieved by only dyeing the positive copy of the film.

It is preferable if the adhesive tape only covers the image section but leaves the perforation free. It is thereby possible to use the perforation for transporting the film also during masking and during removal of the masking so that precise transport is possible and also the running length can be detected exactly.

### DESCRIPTION

Embodiments are explained in detail hereinafter with reference to an exemplary embodiment. The method of the exemplary embodiment according to the invention includes the following.

Initially, checking and recording are performed. The film is checked in an initial checking for any damage, such as cracks in the film, damaged perforation holes and repaired. Then, the colours are recording.

Next, copying is performed. The original is copied onto black-and-white negative film. A black-and-white copy (positive film) is the prepared.

Masking is then performed, in which the black-and-white copy is masked except for the scenes which are to be dyed with the first colour. The masking is accomplished using special adhesive tape.

Toning is then performed. This includes toning the film with the first colour. This means that the film runs through several baths (as explained hereafter) in a modified development machine. A first bath, such as, for example, a source bath, is performed in order to soften the gelatine layer. An inking bath is then performed. A rinsing is then performed in order to remove the dye on the film gloss side and harden the gelatine on the reverse side of the film. After rinsing, for each colour, drying and then checking and masking the scenes which have just been dyed and unmasking the scenes which are to be dyed with the next step.

A final check is then performed, and lastly, delivery.

Embodiments make it possible to dye films simply and true to the original at low expense and whilst preserving conservational aspects.

1-5. (canceled)

6. A method for partially dyeing a film having perforations, comprising:
covering a coating side of the film with an adhesive tape which completely covers image sections not to be dyed; and then
guiding a black-and-white film through a dye bath.

7. The method of claim 6, further comprising:
treating the film to an inking bath; and then
removing the adhesive tape.

8. The method of claim 6, wherein the adhesive tape also covers edges of the film with the perforations in sections which are not to be dyed.

9. The method of claim 6, wherein the adhesive tape only covers image sections and not the perforations.

10. A method for partially dyeing a film having perforations, comprising:
partially covering a cohesive film strip in one piece several times in succession with an adhesive tape; and then
guiding the cohesive film strip film through a dye bath.

11. The method of claim 10, further comprising:
treating the film to an inking bath; and then
removing the adhesive tape.

12. The method of claim 10, wherein the adhesive tape also covers edges of the film with perforations in sections which are not to be dyed.

13. The method of claim 10, wherein the adhesive tape only covers image sections and not the perforations.

14. A method for partially dyeing a film, comprising:
checking the film for damage;
recording colours to be used to dye the film;
copying an original onto a black-and-white negative film;
preparing a black-and-white film;
masking, using an adhesive tape, the black-and-white copy except for sections which are to be dyed;
toning the film with a first colour.

15. The method of claim 14, wherein the toning comprises:
guiding the film through a source bath in order to soften a gelatine layer;
guiding the film through an inking bath;
rinsing the film in order to remove dye from a gloss side of the film gloss and harden the gelatine on a reverse side of the film;
for each colour, drying, checking and masking the portions of the film which have been dyed and unmasking other portions of the film which are to be dyed subsequently.
